(19) United States
(12) Patent Application Publication
(10) Pub. No.: US 2026/0352142 A1
(43) Pub. Date: Nov. 5, 2026

(54) METHOD OF POSITIONING PHOTOVOLTAIC PANELS AND TWO-AXIS TRACKER

(71) Applicants: Andrzej WRECZYCKI, Czestochowa (PL); Michal WRECZYCKI, Palos Park, IL (US); Lukasz STEFANSKI, Czestochowa (PL)

(72) Inventor: Andrzej WRECZYCKI, Czestochowa (PL)

(21) Appl. No.: 19/488,041

(22) PCT Filed: May 28, 2024
(86) PCT No.: PCT/PL2024/000030

§ 371 Date: Nov. 25, 2025

(30) Foreign Application Priority Data
May 26, 2023 (PL) P.445021

(51) Int. Cl. H02S 20/32; G05D 3/10

(52) U.S. Cl. CPC H02S 20/32; G05D 3/105

(57) ABSTRACT

A method for positioning PV photovoltaic panels in a tracking system, in an open control system, according to the solar calendar and azimuth, using a tracker structure with parallectic axes of rotation, as well as a clock mechanism and the solar tracker obtained in this way. According to the invention, the perpendicular arrangement of the panels (1) to the Sun, during its apparent migration across the sky, is a consequence of the movement of the shaft (3) as a result of combining rotational movements in the O1 axis in the cycle of the solar year and in the 02 axis in the daily cycle. The support column (2), located in the north-south axis, is mounted to the foundation tiltably and adjustably in the O1 axis, accordingly to the value of the angle of incidence of solar rays α on a given day.

The subject of the invention is a tracking method for PV photovoltaic panels in a tracking system and a two-axis tracker that implements a control algorithm based on the solar calendar, azimuth and special tracker instrumentation.

With regard to the method of positioning the panels in trackers that work in a tracking system, control algorithms are used in closed, open or hybrid systems. In closed systems, the controller, using lighting or GPS sensors, determines the optimal position of the photovoltaic system in relation to the Sun at a given moment and moves the structure accordingly. Data from the astronomical calendar is used in open control systems.

The method according to the invention concerns control in an open system. In known solutions of this type, control based on the calculated position of the Sun is implemented using commercially available PLC controllers that have a built-in control unit, e.g. STM32 NUCLEO microcontroller with a built-in real-time clock (RTC) system or solar calculators, e.g. S7-1200 :SPA_Calc_Sun_Vector and specialized KNX, Modbus communication blocks. The relationships that allow us to calculate the current position of the Sun on a specific day, hour and minute, are very complicated. For example, the available “NOAA_Solar_Calculations” files are used, which should be adjusted to the established longitude and latitude, including the time zone. In automatic mode, after changing the position of the Sun by 1°, the controller activates a linear actuator for a set time, which rotates the structure in space.

The method according to the invention uses a different control method in an open system. Data from the solar calendar are used, concerning the angle of incidence of rays in the solar year cycle for a specific latitude and the real time of the Sun's upper culmination, combined with an unusual mechanism in which the azimuth-related positioning of the tracker plays a key role.

Regarding the structure of two-axis trackers, regardless of the adopted control system, a rotating head/connector is placed on the mast/pole/support column vertically attached to the foundation, enabling the frame with panels to be moved in an azimuth within 2400-2700 and vertically from 0 to 90°. The connection of the panels with the head/connector, located in the geometric centre of the frame, is a critical element of the tracker's design. During the daily work cycle, the control systems place the frame with panels behind the Sun and then return to the starting point. The disadvantage of two-axis trackers is the complicated control system and the mechanical strength of the structure at the point where the frame with panels is connected to the head/connector.

A photovoltaic panel tracker is known from the Polish utility model application W. 129483, which, through a system of beams and actuators mounted on a stable pole, enables bi-axial, vertical and horizontal movement of the frame with photovoltaic panels. A support structure with two axes of rotation for photovoltaic panels and a system for rotation in two axes of rotation is known from the application No. P.438100 of the Polish invention, in which a vertical mast attached to the base can rotate around its own longitudinal axis and a frame with photovoltaic panels is mounted in its upper part connected to it swingably. The international patent application W020120300225 describes a solar panel assembly in a system of parallactic rotation axes, where the azimuth rotation drive of the panels is coupled with the up-down tilt of the panels. Additionally, series-connected autonomous trackers have a common drive system. In patent description US2010175741, the panels can be mounted rotatably along the longitudinal axis of the rotating frames. The controller can synchronize the tilting of the panels and the rotation of the frames so that the panels are set perpendicularly to the direction of solar radiation. The application description P.442010 provides a mounting method for positioning the photovoltaic panel frame. Its essence is that it consists of a vertical pole attached to the ground and at the other end of the pole there is a sleeve attached using a ball joint, in which there is a slidingly mounted rod coupled with a profiled guide attached to the ground. The description of patent application CN107425794A presents a panel mounting mechanism, in which more than one arc-shaped element is attached to a support frame on the opposite side of the frame's rotation axis. The description of patent application CN108964594A presents a mechanism for positioning a photovoltaic panel placed on a pedestal, which is mounted on a base set at an appropriate angle, depending on the latitude, and it is seated on a rotating pin. The description of patent application CN109347416A presents a mechanism for rotating a photovoltaic module using a connecting rod, the upper end of which is movably connected to the module frame and the lower end of which is movably connected to a spherical sliding block in the mounting plate. In various known solutions of mounting mechanisms for photovoltaic panels, the problem is to position them in the optimal position towards the Sun.

The purpose of the invention is to determine a method of positioning photovoltaic panels perpendicular to the direction of the sun's rays to obtain the maximum conversion of solar energy into electric current. This task was solved according to the invention by developing an innovative control algorithm, which included a discerned particular regularity resulting from the perpendicular to the Sun arrangement of panels on the solar meridian during the time of upper culmination of the Sun, which achieves the goal in combination with the design of the tracker with parallectic axes of rotation and a clock mechanism.

Specific objectives of the invention include: 1. developing a method for positioning photovoltaic panels perpendicular to the direction of incidence of sun's rays from dawn to sunset; 2. development of a mechanism for controlling panels in the tracking system with means of an algorithm using the azimuth and solar calendar as well as tracker instruments; 3. determining the calibration method of the control mechanism; 4. developing a procedure for safe assembly of panels; 5. structural reinforcement of the tracker's resistance to wind gusts; 6. development of a two-axis tracker structure to achieve objectives 1-5.

An important feature of the invention is: generating a perpendicular positioning of the panels to the Sun during its apparent journey across the sky, subsequently movement of the shaft (3) as a result of combining rotational movements in the O1 axis in the solar year cycle and in the O2 axis in the daily cycle.

An important feature of the invention is that the shaft (3) is mounted in a support column (2) located in the north-south axis and tiltable in the O1 axis to the north at an angle β, where β=90°−angle α of incidence of rays for a given latitude.

An important feature of the invention is that a frame (4) with panels (1) is rigidly attached to the shaft (3).

An important feature of the invention is that the rotation of the shaft (3) in the O2 axis is uniform in the direction from east to west by 360° in a daily cycle.

An important feature of the invention is that during the daily cycle of the shaft (3) rotation when the Sun is in upper culmination, the panels (1) are positioned perpendicular to the direction of the Sun's rays and the transverse edges (8) are levelled to the axis of the shaft (3) in the frame (4).

An important feature of the invention is that the supporting column (2) situated in the north-south axis is mounted to the foundation swingably and adjustable in the O1 axis.

An important feature of the invention is that the column tilts north at an angle β, where β=90°−angle α of incidence of rays in a solar year for a given latitude.

An important feature of the invention is that the panels (1) in the frame (4) are rigidly mounted to the shaft (3) rotatably mounted in the column (2) along the longitudinal axis O2.

An important feature of the invention is that the free end of the shaft is slidably connected to the stabilizing support (5) anchored to the foundation.

An important feature of the invention is that the rotation of the shaft in the O1 and O2 axes positions the panels perpendicular to the direction of incidence of the rays when the Sun is in upper culmination, which implies levelling of the transverse to the shaft axis (3) edges (8) in the frame (4).

An important feature of the invention it is that the shaft (3) in the O2 axis rotates 360° evenly at direction from east to west in the daily cycle from upper culmination to upper culmination of the Sun.

An important feature of the invention is that the calibration of the tracker is based on the use of characteristic sequences of the operating mechanism: levelling the transverse edges (8) in the frame (4) when the Sun is upper culmination or lower culmination or vertically positioning the panels at 6 a.m. and 6 p.m. according to real time, whereas in the emergency position of the tracker, the transverse edges (8) of the frame (4) are level and the support column (2) is tilted horizontally.

Advantages of the invention pertain to several aspects: 1. the panels are permanently and invariably positioned perpendicular to the sun's rays during the entire apparent migration of the Sun from dawn to sunset, also during the lower culmination of the Sun, which has the beneficial effect of increasing the efficiency of converting solar energy into electricity, which is the essence of the development of photovoltaics; 2. unidirectional rotation of the panels with the Sun simplifies the method of controlling the panels and the design of the mechanism, because there is no need to adjust (retract) the panels to the position waiting for the sunrise each time; 3. the panel tracking algorithm does not require the use of lighting and GPS sensors, PLC controllers, or microcontrollers that determine the position of the Sun based on complicated computer programs; 4. calibration of the mechanism refers directly to physical quantities that can be measured with simple devices: compass, spirit level, plumb bob, clock; 5. the frame with panels is mounted rigidly to the shaft that runs through the column, which increases the mechanical strength of the structure; 6. the shaft with panels is mounted dually between the support column and the support anchored to the ground, which increases the tracker's resistance to wind; 7. during the daily cycle, the panels perform only two types of movement: a minimal change in the tilt angle in the column mounting axis and a uniform rotation of the shaft around its own axis, which facilitates control and additionally translates into low electricity consumption; 8. in an emergency situation, the tracker folds to the ground level, which is important in the event of strong wind; 9. the panels can be folded with the installation or photosensitive side to the ground, which facilitates cleaning and maintenance of the panels; 10. the equipment of the tracker mechanism consists of standard simple mechanical gears and actuators, and the control system does not require the use of lighting and GPS sensors, which translates into the costs of production and operation of the tracker. 11. in a daily cycle, the panels rotate 360° relative to the ground, which causes them to self-clean during snowfall; 12. the proposed solution reduces the fixed costs of system production, reduces operating costs, and increases the reliability of photovoltaic structures.

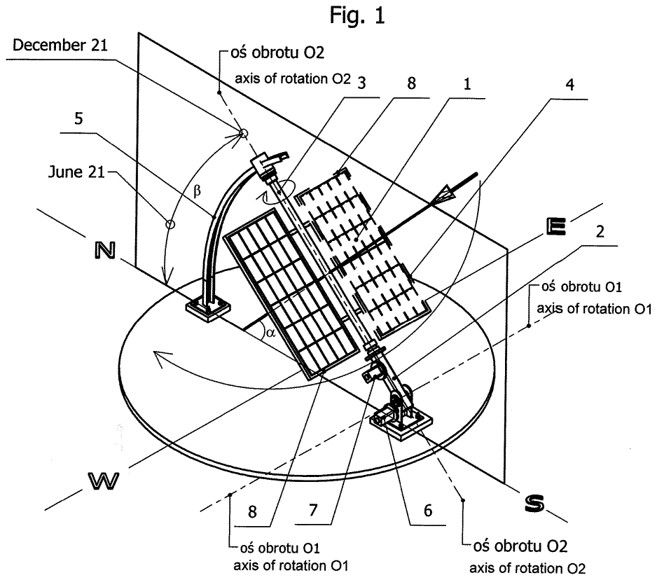

The subject of the invention in a preferred embodiment is shown in the drawing, in which FIG. 1 shows the structure, mechanism of operation and method of guiding the panels in a tracker operating in a tracking system and in an open control system.

According to the embodiment, the tracker consists of photovoltaic panels (1) mounted in a frame (4), a supporting column (2), a shaft (3), a stabilizing support (5), a column tilt actuator (6) with a controller and a shaft rotation actuator (7) with a clock mechanism. The support column (2) is situated on the north-south axis determined by a magnetic compass. The support column (2) in the base is mounted to the foundation tiltably and adjustably in the O1 axis, according to the value of the β angle, calculated on the basis of the relationship β=90−angle α of incidence of rays in a solar year for a given latitude. In the support column (2), along its longitudinal axis O2, a shaft (3) is mounted, to which a frame (4) with panels (1) is rigidly attached. The free end of the shaft (3) is slidably connected along the arched stabilizing support (5) anchored to the foundation. The angle of setting the support column in the O1 axis is changed with means of the actuator (6) with a programmed controller. The rotation of the shaft (3) in the O2 axis is carried out with means of the actuator (7) with a clock mechanism. The shaft rotates evenly in the direction from east to west by 360° in the daily cycle from upper culmination to upper culmination of the Sun. The support column (2) and the bearing shaft (3) mounted in it are made of steel and have the shape of pipes that are placed coaxially.

The method of positioning photovoltaic panels is shown in the embodiment.

In the tracking method, the position of the panels (1) relative to the Sun is the result of the movement of the shaft (3) as a result of combining rotational movements in the O1 axis in the solar year cycle and in the O2 axis in the daily cycle. The rotation of the shaft during the daily cycle is a component of the azimuth movement of the panels. The change in the angle β of the column tilt is a component of the panel movement in an up-down arrangement, depending on the position of the Sun in the solar year.

The basic element that constitutes a reference point for the method of tracking the panels and the basis of the control mechanism is the tilting support column (2) situated in the north-south axis. The tilt of the column to the north is correlated with the angle of incidence of the sun's rays on a given day according to the relationship: tilt angle of the column β=90°−angle α of incidence of rays in a solar year for a given latitude. During the solar year, the angle β of the column tilt changes in two cycles: it decreases from the winter solstice to the summer solstice and then increases until the winter solstice.

A particular discerned pattern is used in the control algorithm: positioning the panels perpendicular to the Sun on the solar meridian when the Sun is in upper culmination results in levelling the transverse to the shaft axis edges of the frame with panels. The effect of levelling the transverse edges of the frame when the Sun is in upper culmination constitutes the essence of the panel tracking mechanism. The consequence of this relationship is the fact that at each upper culmination of the Sun on any day of the solar year, when on the solar meridian the panels are arranged perpendicular to the direction of the sun's rays but obliquely at an angle β to the ground, the edges of the frame transverse to the shaft axis must be arranged horizontally, which is basis for calibration of the mechanism. The result and consequence of the rotational movement of the shaft in the daily cycle, correlated with the apparent movement of the Sun in the sky, is also the vertical positioning of the panels at 6 a.m. and 6 p.m. according to real time, which is also a characteristic reference point for calibrating the mechanism. The obvious consequence is also levelling the transverse edges of the frame at midnight when the sun is in lower culmination, but then the panels are turned with the photosensitive side towards the ground

The tracker's operating algorithm requires meeting the initial conditions for its location and instrumentation:
A. Data for the tracker location: 1. determining the direction of the north-south axis; 2. making the calculation of the angle β of the column inclination; 3. determining the moment of the Sun's upper culmination and therefore calculating the time of solar noon according to real time; 4. calculation of the true time equivalent to 6 a.m. and 6 p.m. according to local time.
B. Tracker instruments: 1st column: mounted on the north-south axis, tiltable towards the north, with a tilt angle ranging from 0° (emergency position) to the calculated maximum value of angle β, tilt angle adjusted by the actuator; 2. Frame with panels mounted to the shaft mounted in the tiltable column; 4. rotation of the shaft with means of the actuator; 5. operation of actuators via programmed controllers: a) column tilt actuator—from 0° when levelling the tracker to the calculated angle β; b) shaft rotation actuator—evenly, in the east-west direction, by 360° in a daily cycle.

Tracker calibration is based on the use of characteristic sequences of the operating mechanism: 1. adjustable tilt of the column in the north-south axis according to angle β; 2. horizontal positioning of the transverse edges of the frame when the Sun is in upper culmination and lower culmination; 3. vertical position of the panels at 6 a.m. And 6 p.m. in real time; 4. daily cycle of panel rotation according to real time. Measurable and objective reference points are used for calibration: 1. determining the north-south direction with a compass; 2. determining the horizontal and vertical direction using a spirit level and a plumb bob; 3. real time determined by the clock, calculated after taking into account the correction of the time equation to local time.

Calibration and activation of the tracker is carried out in the following order. 1. tilting the support column (2) at an angle β according to the day date; 2. levelling (according to the spirit level), with means of the actuator (7), of the transverse edges (8) of the frame (4) when the Sun is in upper culmination or lower culmination, or arranging the panels vertically (according to the vertical) at 6 a.m. and 6 p.m. according to real time; 3. activation of the shaft rotation actuator (7) and the column tilt actuator (6) in the programmed time interval.

Emergency assembly of the tracker may occur at any time (e.g. as a result of an anemometer reading), while calibration may take place at an appropriate time when the characteristic sequences of the operating mechanism occur. Emergency procedures in case of strong wind, maintenance, washing of panels: 1. levelling the transverse edges (8) of the frame with means of the shaft rotation actuator (7); 2. Positioning the column horizontally with means of the column tilt actuator (6).

According to the invention, the actual orientation of the panels to the Sun is a consequence of the movement of the shaft (3) as a result of combining rotational movements in the O1 axis in the solar year cycle and in the O2 axis in the daily cycle. In the daily cycle, the rotation of the shaft with the panels in the column tilted at an angle β, correlated with the adequate arrangement of the panels during the upper culmination and lower culmination of the Sun and at 6 o'clock 0 and 18⁰⁰ according to real time, implies the perpendicular arrangement of the panels to the Sun 24 hours a day.

According to the invention, an algorithm for tracking the photovoltaic PV panels in a tracking system, in an open control system, according to the solar calendar, azimuth, tracker structure with parallectic axes of rotation and clock mechanism, is as follows: if the following components are synchronized based on the presented design solution: 1. deflection of the support column in the north-south axis at an angle β; 2. setting the panels in the appropriate position relative to real time; 3. rotation of panels in a daily cycle;—then, by nature, the panels will be positioned perpendicular to the Sun in its apparent migration all day, which is the essence of the tracker.

Locating the tracker in the embodiment at a given latitude allows to specify the scope of operation of the tracker mechanisms. For example, for Warsaw 21° E 52° N; angle of incidence of Sun rays: winter solstice 14° and summer solstice 61° and the angular deflection of the column β, calculated on the basis of the dependencies β=90−angle α of incidence of rays in a solar year for a given latitude, is approximately in the range of 47°, between 76° for the winter solstice and the 29° for the summer solstice. The horizontal arrangement of the transverse edges of the panel frame occurs at 12.35 and 0.35 a.m. during the upper culmination and lower culmination of the Sun, and the vertical arrangement of the panels occurs at 6.35 a.m. and 6.35 p.m. according to local time, after taking into account the correction of the time equation.

1. Method of positioning PV photovoltaic panels in a tracking system, in an open control system, according to the solar calendar and azimuth, using a tracker structure with equatorial axes of rotation and a clock mechanism, characterized in that the perpendicular positioning of the panels (1) to the Sun during its apparent migration across the sky is a consequence of the movement of the shaft (3) as a result of combining rotational movements in the O1 axis in the solar year cycle and in the 02 axis in the daily cycle, whereas the shaft (3) is mounted in a support column (2) situated in the north-south axis and tiltably set in the O1 axis to the north at an angle β, where β=90°−angle α of incidence of rays for a given latitude, and in turn the rotation of incidence of the rays at time of the upper culmination of the Sun, which implies levelling of the edges (8) transverse to the axis of the shaft (3) in the frame (4), whereas the shaft (3) in the O2 axis makes even rotation by 360° in the direction from east to west in the daily cycle from the upper culmination to the upper culmination of the Sun, at the same time tracker calibration is based on the use of characteristic sequences of the operating mechanism levelling the transverse edges (8) in the frame (4) when the Sun is in upper culmination or lower culmination or vertically positioning the panels at 6 a.m. and 6 p.m. according to real time, while in the emergency tracker setting the transverse edges (8) of the frame (4) are level, and the support column (2) is tilted horizontally.

2. Two-axis tracker for positioning photovoltaic PV panels, consisting of a support column (2), a stabilizing support (5), a shaft (3) with panels (1), actuators (6) and (7) with controllers, characterized in that the support column (2) situated in the north-south axis is mounted to the foundation tiltably and adjustably in the O1 axis at its base, with the column tilting north at an angle β, where β=90°−angle α of incidence of rays in a solar year for a given latitude, while panels (1) in the frame (4) are rigidly mounted to the shaft (3) rotatably mounted in the column (2) along the longitudinal axis O2, and the free end of the shaft is slidably connected to the stabilizing support (5) anchored to the foundation.
